(19) United States
(12) Patent Application Publication
(10) Pub. No.: US 2026/0070244 A1
(43) Pub. Date: Mar. 12, 2026

(54) RAZOR WITH INTERCHANGEABLE EJECTOR BLADE SYSTEM

(71) Applicant: Paul Engram, III, Raleigh, NC (US)

(72) Inventor: Paul Engram, III, Raleigh, NC (US)

(21) Appl. No.: 19/008,771

(22) Filed: Jan. 3, 2025

Related U.S. Application Data
(60) Provisional application No. 63/691,462, filed on Sep. 6, 2024.

(51) Int. Cl. B26B 21/10; B26B 21/52

(52) U.S. Cl. CPC B26B 21/10; B26B 21/525

(57) ABSTRACT

A device may include a handle comprising a hollow portion configured to operate as a chamber to encompass a razor blade when in a closed position. A device may include a cutting component connected to the handle via a swivel pivot point, the swivel pivot point configured to enable the cutting component to be directed to create varying degrees of openness relative to the handle, wherein the cutting component comprises an elongated metal portion that includes a blade retainer integrated into the cutting component. A device may include a blade adaptor configured to be received within the blade retainer, the blade adaptor includes an internal portion configured to hold smaller ejector blades securely within the blade retainer; and wherein the blade retainer comprises a slide mechanism configured to secure the blade adaptor within the blade retainer or eject the blade adaptor from the blade retainer, wherein the slide mechanism is configured to eject the blade adaptor upon a slide of the slide mechanism being slid along a slide channel, causing the blade adaptor to be removed from a distal end of the blade retainer.

### CROSS-REFERENCE TO RELATED APPLICATIONS

This application claims the benefit of priority to U.S. provisional application No. 67/068,893, filed on Sep. 6, 2024, which is expressly incorporated by reference herein in its entirety.

### FIELD OF THE TECHNOLOGY

The present invention relates generally to razors and, more particularly, to a straight razor that includes an ejector system designed for the efficient interchanging of a plurality of blades.

### BACKGROUND

Razor blades are essential tools for grooming and shaving body and facial hair. They are commonly utilized in professional barbershops and personal grooming at home. The primary types of razors include straight razors, safety razors, and cartridge razors, each offering distinct advantages and limitations. Straight razors are known for their precision and close shave, making them a preferred choice among professional barbers. Safety razors and cartridge razors are more commonly used for home grooming due to their ease of use and reduced risk of nicks and cuts.

In barbershops, the use of high-quality razors is critical for achieving precise and clean shaves, as well as for executing various styling techniques. Barbers rely on sharp, hygienic blades to provide customers with optimal results. The ability to quickly and efficiently change blades between clients is important for maintaining high standards of hygiene and ensuring a sharp blade is always available for use.

For home use, convenience and versatility are key factors. Users benefit from razors that can accommodate different blade types for various grooming needs, such as achieving a clean-shaven look or maintaining a specific facial hair style. The ability to easily interchange blades enhances the overall shaving experience by allowing users to tailor their grooming routine to their specific preferences.

### BRIEF DESCRIPTION OF THE SEVERAL VIEWS OF THE DRAWINGS

Details of one or more embodiments of the subject matter described in this disclosure are set forth in the accompanying drawings and the description below. However, the accompanying drawings illustrate only some typical embodiments of this disclosure and are therefore not to be considered limiting of its scope. Other features, embodiments, and advantages will become apparent from the description, the drawings and the claims.

FIG. 1 illustrates a razor device in a closed position according to some aspects of the disclosure;

FIG. 2 illustrates a razor device in an open position according to some aspects of the disclosure;

FIG. 3 illustrates an inside portion of the razor device in and open position according to some aspects of the disclosure.

### DETAILED DESCRIPTION

Various examples of the disclosure are discussed in detail below. While specific implementations are discussed, it should be understood that this is done for illustration purposes. A person skilled in the relevant art will recognize that other components and configurations can be used without parting from the spirit and scope of the disclosure. Thus, the following description and drawings are illustrative and are not to be construed as limiting.

Numerous specific details are described to provide a thorough understanding of the disclosure. However, in certain instances, well-known or conventional details are not described in order to avoid obscuring the description. References to one or an example in the present disclosure can be references to the same example or any example; and such references mean at least one of the examples.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative and is not intended to further limit the scope and meaning of the disclosure or of any example term. Likewise, the disclosure is not limited to various embodiments given in this specification.

For purposes of the description hereinafter, spatial orientation terms, as used, shall relate to the referenced aspect as it is oriented in the accompanying drawings, figures, or otherwise described in the following detailed description. However, it is to be understood that the aspects described hereinafter may assume many alternative variations and configurations. It is also to be understood that the specific components, devices, features, and operational sequences illustrated in the accompanying drawings, figures, or otherwise described herein are simply exemplary and should not be considered as limiting.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

The disclosed technology pertains to a razor device configured to enhance functionality and safety. The razor device includes a handle comprising a hollow portion that functions as a chamber to enclose a razor blade when in a closed position, providing secure storage. Connected to the handle via a swivel pivot point, the cutting component can be positioned at various angles relative to the handle, allowing for precise control during use. This cutting component includes an elongated metal portion with an integrated blade retainer. Additionally, the razor device incorporates a blade adaptor designed to fit within the blade retainer, featuring an internal portion configured to securely hold smaller ejector blades. The blade retainer is equipped with a slide mechanism that can either secure the blade adaptor within the retainer or eject it. This slide mechanism operates by sliding along a slide channel, effectively removing the blade adaptor from the distal end of the blade retainer when needed.

In some aspects, the techniques described herein relate to a razor device including: a handle including a hollow portion configured to operate as a chamber to encompass a razor blade when in a closed position; a cutting component connected to the handle via a swivel pivot point, the swivel pivot point configured to enable the cutting component to be directed to create varying degrees of openness relative to the handle, wherein the cutting component includes an elongated metal portion that includes a blade retainer integrated into the cutting component; a blade adaptor configured to be received within the blade retainer, the blade adaptor includes an internal portion configured to hold smaller ejector blades securely within the blade retainer; and wherein the blade retainer includes a slide mechanism configured to secure the blade adaptor within the blade retainer or eject the blade adaptor from the blade retainer; wherein the slide mechanism is configured to eject the blade adaptor upon a slide of the slide mechanism being slid along a slide channel, causing the blade adaptor to be removed from a distal end of the blade retainer.

In some aspects, the techniques described herein relate to a razor device, wherein the handle includes: a durable polymer; and a curved portion configured to contour a user's hand to provide an ergonomic grip and balance of the razor device.

In some aspects, the techniques described herein relate to a razor device, wherein the blade retainer is configured to receive a razor blade within a retaining portion of the blade retainer, wherein the blade retainer includes a wider base portion for holding a non-cutting part of the razor blade and a narrower portion for press-fit installation of the razor blade.

In some aspects, the techniques described herein relate to a razor device, wherein the blade retainer is configured to secure the razor blade within the blade retainer or eject the razor blade from the blade retainer via the slide mechanism.

In some aspects, the techniques described herein relate to a razor device, wherein the blade retainer includes: a wider base portion for holding a non-cutting part of the razor blade; a narrower portion for press-fit installation of the razor blade, configured to securely hold the razor blade in place; and an internal structure that contacts all sides of the razor blade to maintain a secure fit, allowing a cutting portion of the razor blade to protrude from a top of the blade retainer.

In some aspects, the techniques described herein relate to a razor device, wherein the cutting component can retain a full-size blade within the blade retainer.

In some aspects, the techniques described herein relate to a razor device, wherein the blade retainer is designed to accommodate razor blades of sizes 2.5 cm, 5 cm, and 7.5 cm.

In some aspects, the techniques described herein relate to a razor device, wherein the slide mechanism is configured to move from a first position, which is a locking position, to a second position, which is a release position, to secure or release the razor blade from the blade retainer.

In some aspects, the techniques described herein relate to a razor device, wherein the blade adaptor is configured to receive a smaller blade within a hollow retention area, securing the razor blade at multiple points along its length for stability during intricate grooming tasks.

In some aspects, the techniques described herein relate to a razor device, wherein the slide mechanism includes a locking device configured to attach to a portion of a base of the razor blade when in a locked position, thereby securing the razor blade firmly within the blade retainer.

### EXAMPLE EMBODIMENTS

Additional features and advantages of the disclosure will be set forth in the following description and, in part, will be apparent from the description or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Current straight razors, both in professional barbershops and for personal grooming at home, present significant challenges related to blade safety and versatility. Traditional straight razors often do not offer a safe and efficient way to remove and replace the blade. Users are subject to potential injury during the blade-changing process, as the existing technology does not adequately safeguard against accidental cuts. This risk is particularly pronounced in professional settings, where barbers must frequently change blades to maintain hygiene and ensure a sharp edge for each client. The manual process of removing and installing blades can be cumbersome and hazardous, interrupting the workflow and increasing the chance of injury.

Additionally, existing straight razors are typically designed to accommodate only one type of blade. This limitation restricts the versatility of the razor, preventing users from easily switching between different blade types to suit various grooming needs. For instance, a barber might require a different blade for edging compared to general shaving, and home users might prefer different blades for facial and body hair. The inability to interchange blades efficiently hinders the overall functionality and convenience of the razor.

Efficient and effective blade interchangeability is crucial in both professional and personal grooming contexts. In barbershops, the process of changing blades needs to be swift and straightforward, enabling barbers to maintain a continuous workflow without interruptions. A well-designed blade ejector system allows for quick removal and secure installation of new blades, ensuring minimal downtime between clients. This capability is particularly beneficial during peak business hours when demand for services is high.

For individual users, an intuitive blade interchange system enhances the convenience of home grooming. It allows users to effortlessly switch between different blade types or replace dull blades, maintaining the effectiveness of their shaving routine. This adaptability is especially useful for individuals who prefer to experiment with various shaving styles or those who require different blades for shaving different parts of the body. An effective blade ejection system ensures that users can make these adjustments with minimal effort, enhancing their overall grooming experience.

The proposed technology addresses these challenges by introducing a straight razor system with an ejector system for interchanging a plurality of blades of different sizes and types. This innovative solution provides a safe and efficient method for changing blades, significantly reducing the risk of injury. The ejector system facilitates quick and secure blade changes, allowing barbers to maintain a seamless workflow and ensuring home users can easily adapt their grooming tools to their specific needs.

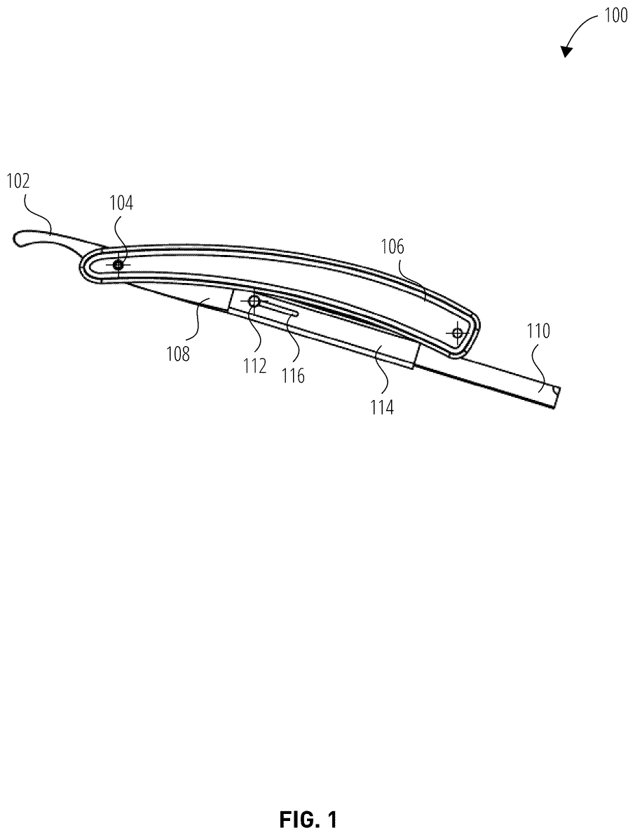

FIG. 1 illustrates a razor device 100 in a closed position according to some aspects of the disclosure. Razor device 100 is designed to cater to both professional and non-professional users, providing a safer method for removing and replacing razor blades. This innovative design ensures better balance and weight distribution, resulting in a smoother shaving experience. The device offers the flexibility to choose between a full blade or an ejector blade, enhancing its versatility for various shaving needs.

The razor device 100 comprises a handle 106 that is curved and constructed from durable polymer. The handle 106 is designed to balance the razor device effectively while retaining a razor blade during shaving. Notably, the handle 106 is hollow in the middle, doubling as a chamber holder to encompass the blade when in a closed position, as shown in FIG. 1. This ergonomic design provides a comfortable grip and contributes to the overall balance of the razor.

The handle 106 connects to a cutting component 108 via a swivel pivot point, allowing for a wide range of motion. This pivot point enables the cutting component 108 to be directed to create varying degrees of openness relative to the handle 106, providing precise control and flexibility during use. The cutting component 108 features an elongated metal portion that includes a blade retainer 114. Blade retainer 114 further includes a slide 112 that allows a user to secure a razor blade into the blade retainer 114 or eject the razor blade, causing a release of the razor blade from the blade retainer 114.

The blade retainer 114 is designed to accommodate razor blades of various sizes, such as 2.5 cm, 5 cm, and 7.5 cm. It comprises a wider base portion that securely holds the non-cutting part of the razor blade and a narrower portion that allows for a press-fit installation. When the razor blade is pressed into the blade retainer 114, it is securely held in place by the internal structure of the blade retainer 114, which contacts all sides of the blade. This secure fit ensures that the cutting portion of the razor blade protrudes from the top of the retainer 114, allowing for effective and precise shaving. Additionally, the cutting component 108 can retain a full-size blade within the blade retainer 114.

Alternatively, blade retainer 114 can receive a blade adaptor 110 instead of a standard razor blade. Blade adaptor 110 is configured to accommodate smaller blade sizes, making it ideal for more intricate and well-defined shaves. By receiving a smaller razor blade within blade adaptor 110, users can be enabled to perform detailed grooming tasks, such as shaping a goatee, providing a precise lineup for sensitive areas of the skin, or creating intricate designs in a patron's hair. By utilizing the blade adaptor 110, razor device 100 extends its functionality beyond typical shaving applications, offering enhanced precision and control for specialized grooming needs.

Razor device 100 is configured to enhance safety by minimizing the risk of accidental cuts during blade changes, and it also improves overall shaving performance. The secure blade retention mechanism ensures that the blade remains firmly in place during use, providing a consistent and reliable shaving experience. Additionally, different blade types and sizes allow users to tailor the razor to their specific grooming needs, whether for facial or body hair.

The secure blade retention mechanism of the razor device 100 ensures that the blade remains firmly in place within the blade retainer 114 during use. This stability is crucial for maintaining precision and safety while shaving. The blade retention system is configured to securely retain the blade, preventing any movement or shifting that could compromise the quality of the shave or pose a risk to the user.

In one embodiment, the handle 106 may include a removable or interchangeable grip portion that allows for different textures, materials, or sizes to accommodate various user preferences. By substituting grip attachments, users can customize the comfort level of the razor device 100 while still benefiting from the ergonomic hollow handle design.

In another embodiment, the pivot point 104 may incorporate a multi-stage locking mechanism. This mechanism can be configured to lock the cutting component 108 at one or more predetermined angles relative to the handle 106. As a result, users can set the razor device 100 in a fixed open position, promoting consistency during extended shaving sessions or intricate detailing.

Further embodiments may include an adjustable tension system for the slide 112 within the blade retainer 114. This system could utilize a small, integrated dial or lever that fine-tunes the slide's friction against the blade or blade adaptor 110..

Yet another embodiment involves incorporating an alignment guide on the blade adaptor 110 or along the interior walls of the blade retainer 114. The alignment guide ensures that smaller blades are seated accurately, reducing the likelihood of uneven blade positioning.

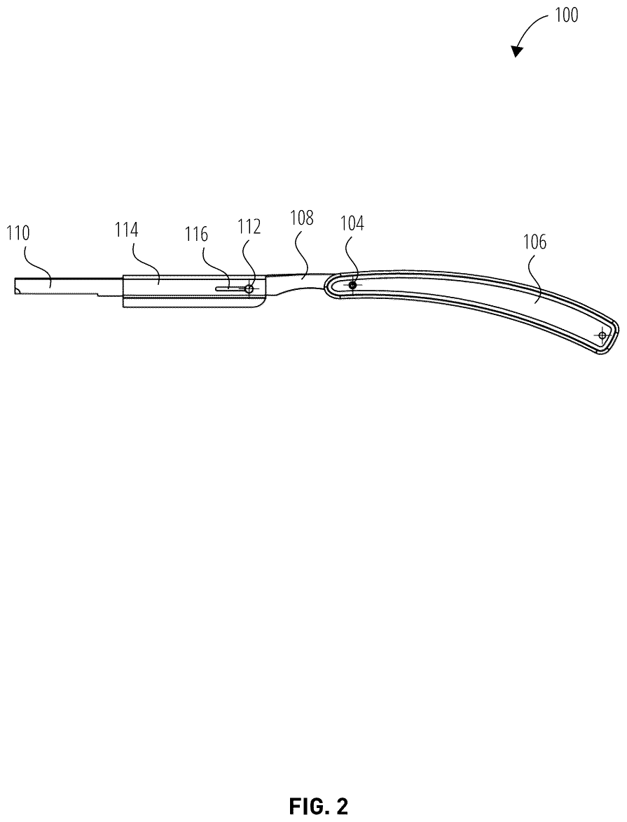

FIG. 2 illustrates a razor device 100 in an open position according to some aspects of the disclosure. When the razor device 100 is in use, the handle 106 is configured to pivot about pivot point 104, allowing the handle 106 to be positioned at varying angles relative to the cutting component 108. This pivot functionality is integral to the design, providing users with the flexibility to adjust the angle of the handle 106 to suit different shaving needs and techniques.

By directing the handle 106 of the razor device 100 at varying angles, users can create an optimal balance between the handle 106 and the cutting component 108. This adjustability ensures that pressure is evenly distributed across the blade, reducing the risk of nicks and cuts while enhancing the overall comfort of the shaving experience. For instance, when shaving more sensitive areas of the body or face, a user can pivot the handle to a more acute angle to apply lighter pressure, thereby minimizing irritation and achieving a gentler shave.

Additionally, the ability to adjust the handle 106 provides better control and precision, particularly for detailed grooming tasks. When lining up a goatee or creating intricate designs in a patron's hair, the user can fine-tune the angle to ensure the blade meets the skin at the correct orientation, allowing for clean, sharp lines and detailed work. This precise control is essential for both professional barbers and individuals who take pride in their grooming routine.

Furthermore, the balanced pressure facilitated by the adjustable handle angle helps to maintain the longevity of the blade. Even pressure distribution ensures that the blade wears evenly, prolonging its sharpness and effectiveness.

To release the blade from the secure retention mechanism, the user can utilize slide 112. This slide operates by moving from a first position, which is the locking position, to a second position, which is the release position. In the locking position, the slide 112 is situated close to the pivot point 104, which includes as a pivot pin, ensuring that the blade is held firmly in the most tense part of the blade retainer 114. When the user slides the slide 112 from the lock position to the release position, the blade is disengaged from the high-tension area, allowing it to be released from the blade retainer 114 and slide out through the distal end of the cutting component 108.

Securing a razor blade back within the retaining portion can be initiated when the blade is placed at the distal end of the blade retainer 114. The user can then slide the bottom portion of the blade along the bottom part of the retainer. As the blade moves along this path, it interacts with the slide 112. The user can then cause slide 112 to move from the release position back to the lock position. Once the slide is in the lock position, the blade is secured within the blade retainer 114 by the tension and the locking mechanism attached to slide 112. This ensures that the blade is held firmly in place and ready for use.

In an example, blade retainer 114 is designed to receive a blade adaptor 110 within its internal structure. Blade adaptor 110 is particularly useful when a smaller, more precise blade is required. The adaptor includes an internal portion configured to securely hold smaller ejector blades within the blade retainer 114. By using the blade adaptor 110, users can achieve greater precision for specific grooming tasks that demand meticulous attention to detail.

For instance, when lining up a goatee, a smaller, more precise blade ensures clean, sharp edges that accurately define the facial hair. This level of precision is crucial for creating symmetrical and well-defined goatee lines that enhance the overall appearance. Additionally, providing a precise lineup for sensitive portions of skin, such as around the lips or under the nose, requires a blade that can navigate these areas without causing irritation or discomfort. The smaller blade held by the blade adaptor 110 allows for careful maneuvering, ensuring a smooth and gentle shave in these delicate regions.

Creating intricate designs in a patron's hair is another task that benefits from the precision offered by the blade adaptor 110. Hair designs, such as patterns or detailed shapes, require a blade that can handle fine lines and intricate curves. The smaller ejector blades, secured by the blade adaptor, provide the control and accuracy needed to execute these designs flawlessly, and without error.

In an example, blade adaptor 110 can be secured within the blade retainer 114. The blade adaptor 110 can receive a smaller type of blade within its hollow retention area. The hollow retention area of the blade adaptor 110 allows a razor blade to be press-fit securely, engaging the blade at multiple points along its length, forming a first securing mechanism. This ensures the blade remains stable and firmly in place during use.

To install the blade adaptor 110 into the blade retainer 114, the user begins by positioning the adaptor at the distal end of the retainer with slide 112 in the release position, closest to the distal end. As the bottom portion of blade adaptor 110 makes contact with the bottom portion of blade retainer 114, the user slides blade adaptor 110 into blade retainer 114, guiding it towards the slide 112. The slide 112 then engages with blade adaptor 110, causing slide 112 to move in a backward motion from the release position to the lock position along slide channel 116. Once slide 112 reaches the lock position, blade adaptor 110 is securely locked in place within blade retainer 114. This secure locking allows the user to proceed with precision shaving, adjusting the angle and rotating handle 106 about a pivot point created by pivot pin of pivot point 104 to navigate intricate areas on the face or body.

To release blade adaptor 110 from blade retainer 114, the user utilizes slide 112. Slide 112 releases the blade adaptor 110 by moving from a first position, which is the locked position, to a second position, which is the release position. By sliding slide 112 from the locked position to the release position, the tension securing the blade adaptor 110 is disengaged. The user then applies force to slide the blade adaptor 110 towards the distal end of the retainer, guided by slide channel 116. Once slide 112 reaches the release position, blade adaptor 110 can be removed from blade retainer 114.

By performing this action, to release blade adaptor 110 from blade retainer 114, a user can re-secure a standard razor blade in blade retainer 114 for continued shaving on different areas of the body or face or to replace the blade for the next patron, ensuring hygiene standards are maintained.

In one embodiment, the handle 106 may include an adjustable grip insert that snaps securely into the hollow portion of the handle. This insert can be composed of various materials or textures to cater to different user preferences for comfort and control.

Another embodiment provides a locking detent mechanism incorporated into the pivot pin of pivot point 104. This mechanism enables the cutting component 108 to remain in one of several fixed positions when the razor device 100 is in use.

In some embodiments, the blade retainer 114 may be fitted with a magnetic element that interfaces with a corresponding element on the blade adaptor 110 or the standard razor blade. The magnetically assisted retention can in some examples, serve as a secondary measure, enhancing overall blade security.

Additionally, an optional safety guard can be integrated into the distal end of the cutting component 108. This guard could be retracted or pivoted away during normal shaving operations, but snapped back into place when the razor device 100 is stored or being transported.

In one embodiment, a secondary latch mechanism may be integrated into the blade retainer 114. This latch can operate independently of the slide 112, providing an additional layer of security when the razor device 100 is in use. By engaging the secondary latch, users can lock the blade retainer 114 in place, preventing unintentional blade ejection or movement, which is especially useful in high-volume or fast-paced shaving environments.

In another embodiment, an alignment window, not shown in FIGS. 1-3, can be included near the distal end of the cutting component 108. This window can be formed as a small cutout or transparent portion in the metal structure, allowing users to visually confirm that the blade or blade adaptor 110 is seated properly within the blade retainer 114.

In a further embodiment, the handle 106 may include an integrated tension adjuster that allows users to fine-tune the swivel resistance at pivot pin of pivot point 104. This adjustment can be made by turning a small screw or dial located on the side of the handle 106. By controlling the swivel tension, users can customize how freely the cutting component 108 moves, thereby tailoring the razor device 100 to their preferred shaving style or level of control.

Yet another embodiment provides for a protective bumper situated on the interior side of the handle 106, aligning with the cutting component 108 when the razor device 100 is in a fully closed position. The bumper can be composed of a soft yet durable material, acting to cushion the contact area between the handle 106 and the cutting component 108.

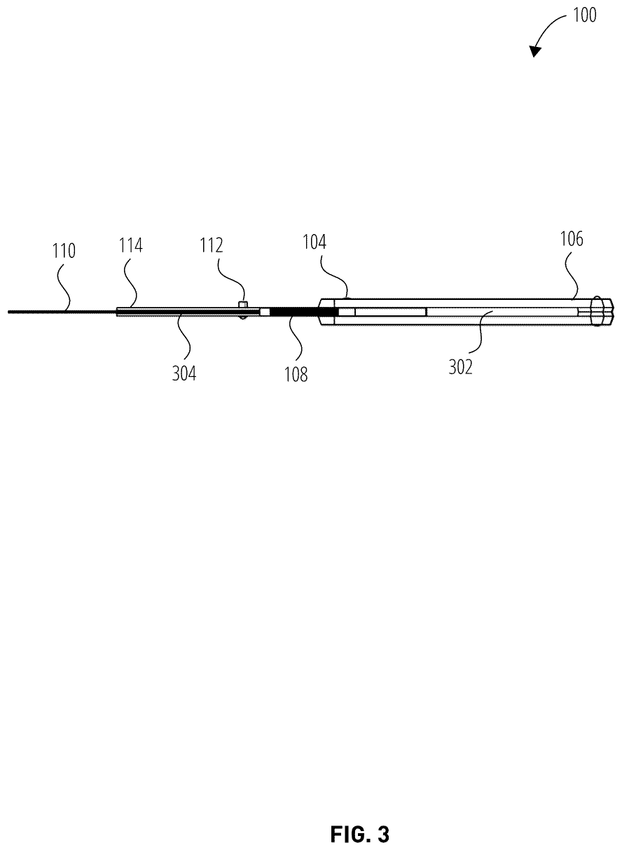

FIG. 3 illustrates an inside portion of the razor device in and open position according to some aspects of the disclosure.

Inside of razor device 100, when a user opens the device, the cutting component retainer 302 within the handle 106 is accessible. This allows the user to access both the cutting component 108 and the blade secured within the blade retainer 114. The cutting component retainer 302 within the handle 106 is designed to retain the cutting component 108 and a razor disposed within the blade retainer 114. When the razor device 100 is in the closed position, as shown in FIG. 1, the razor can be safely secured, and the sharp edge is stored within the hollow portion of the cutting component retainer 302, ensuring safe storage and handling.

The blade securing portion 304 of the blade retainer 114 is configured to receive the razor blade or blade adaptor 110 via the distal end of the blade retainer 114. As the razor is placed within the retainer 114, it slides along the hollowed portion of the blade securing portion 304, securely holding the blade within the blade retainer 114. The blade securing portion 304 is designed to accommodate various blade types, allowing for versatility in shaving tasks.

As described with reference to FIG. 2, the slide 112 extends through the blade securing portion 304, allowing the blade to be physically contacted and engaged. Slide 112 can slidably interact with the blade to secure it within the blade retainer 114 or to forcibly slide the blade out of the blade retainer 114, ensuring a secure and safe removal process. This mechanism eliminates the need for the user to reach down and forcibly pull the blade out of the blade retainer 114, reducing the risk of injury.

Using slide 112 to remove a razor blade enables the user to safely and quickly replace the blade with one of a different size, type, or sharpness, or to replace it with blade adaptor 110. The blade adaptor 110 allows for the retention of a smaller, more intricate blade within the blade securing portion 304, enhancing the razor device's versatility for detailed grooming tasks. This design ensures that blade changes are efficient and safe, meeting the diverse needs of users in both professional and personal grooming contexts.

In one embodiment, the cutting component retainer 302 may include a removable protective lining along its interior walls. This lining can be made from a resilient material, such as silicone or a specialized polymer, to cushion the cutting component 108 and the secured razor blade when the device is closed.

Another embodiment provides a secondary latch within the handle 106 that engages with the cutting component retainer 302 when the razor device 100 is fully closed. This latch can be configured to prevent unintended opening of the device, particularly during transport or storage.

In some embodiments, an alignment guide may be formed along the bottom portion of the blade securing portion 304. This guide can be a raised track or groove that helps position the razor blade or blade adaptor 110 during insertion.

Yet another embodiment contemplates integrating a light source, such as a small LED, near the distal end of the blade securing portion 304. When the razor device 100 is open, the LED can illuminate the interior cavity, allowing the user to see the blade's position and condition more clearly.

A summary of the disclosure is provided in the following clauses.
Clause 1. A razor device comprising: a handle comprising a hollow portion configured to operate as a chamber to encompass a razor blade when in a closed position; a cutting component connected to the handle via a swivel pivot point, the swivel pivot point configured to enable the cutting component to be directed to create varying degrees of openness relative to the handle, wherein the cutting component comprises an elongated metal portion that includes a blade retainer integrated into the cutting component; a blade adaptor configured to be received within the blade retainer, the blade adaptor includes an internal portion configured to hold smaller ejector blades securely within the blade retainer; and wherein the blade retainer comprises a slide mechanism configured to secure the blade adaptor within the blade retainer or eject the blade adaptor from the blade retainer; wherein the slide mechanism is configured to eject the blade adaptor upon a slide of the slide mechanism being slid along a slide channel, causing the blade adaptor to be removed from a distal end of the blade retainer.
Clause 2. The razor device of clause 1, wherein the handle comprises: a durable polymer; and a curved portion configured to contour a user's hand to provide an ergonomic grip and balance of the razor device.
Clause 3. The razor device of clause 1, wherein the blade retainer is configured to receive a razor blade within a retaining portion of the blade retainer, wherein the blade retainer comprises a wider base portion for holding a non-cutting part of the razor blade and a narrower portion for press-fit installation of the razor blade.
Clause 4. The razor device of clause 3, wherein the blade retainer is configured to secure the razor blade within the blade retainer or eject the razor blade from the blade retainer via the slide mechanism.
Clause 5. The razor device of clause 1, wherein the blade retainer comprises: a wider base portion for holding a non-cutting part of the razor blade; a narrower portion for press-fit installation of the razor blade, configured to securely hold the razor blade in place; and an internal structure that contacts all sides of the razor blade to maintain a secure fit, allowing a cutting portion of the razor blade to protrude from a top of the blade retainer.
Clause 6. The razor device of clause 1, wherein the cutting component can retain a full-size blade within the blade retainer.
Clause 7. The razor device of clause 1, wherein the blade retainer is designed to accommodate razor blades of sizes 2.5 cm, 5 cm, and 7.5 cm.
Clause 8. The razor device of clause 1, wherein the slide mechanism is configured to move from a first position, which is a locking position, to a second position, which is a release position, to secure or release the razor blade from the blade retainer.
Clause 9. The razor device of clause 1, wherein the blade adaptor is configured to receive a smaller blade within a hollow retention area, securing the razor blade at multiple points along its length for stability during intricate grooming tasks.
Clause 10. The razor device of clause 1, wherein the slide mechanism comprises a locking device configured to attach to a portion of a base of the razor blade when in a locked position, thereby securing the razor blade firmly within the blade retainer.

While aspects of a razor are shown in the accompanying figures and described hereinabove in detail, other aspects will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

What is claimed is:

1. A razor device comprising:
a handle comprising a hollow portion configured to operate as a chamber to encompass a razor blade when in a closed position;
a cutting component connected to the handle via a swivel pivot point, the swivel pivot point configured to enable the cutting component to be directed to create varying degrees of openness relative to the handle, wherein the cutting component comprises an elongated metal portion that includes a blade retainer integrated into the cutting component;
a blade adaptor configured to be received within the blade retainer, the blade adaptor includes an internal portion configured to hold smaller ejector blades securely within the blade retainer; and
wherein the blade retainer comprises a slide mechanism configured to secure the blade adaptor within the blade retainer or eject the blade adaptor from the blade retainer;
wherein the slide mechanism is configured to eject the blade adaptor upon a slide of the slide mechanism being slid along a slide channel, causing the blade adaptor to be removed from a distal end of the blade retainer.

2. The razor device of claim 1, wherein the handle comprises:
a durable polymer; and
a curved portion configured to contour a hand of a user to provide an ergonomic grip and balance of the razor device.

3. The razor device of claim 1, wherein the blade retainer is configured to receive a razor blade within a retaining portion of the blade retainer, wherein the blade retainer comprises a wider base portion for holding a non-cutting part of the razor blade and a narrower portion for press-fit installation of the razor blade.

4. The razor device of claim 3, wherein the blade retainer is configured to secure the razor blade within the blade retainer or eject the razor blade from the blade retainer via the slide mechanism.

5. The razor device of claim 1, wherein the blade retainer comprises:
a wider base portion for holding a non-cutting part of the razor blade;
a narrower portion for press-fit installation of the razor blade, configured to securely hold the razor blade in place; and
an internal structure that contacts all sides of the razor blade to maintain a secure fit, allowing a cutting portion of the razor blade to protrude from a top of the blade retainer.

6. The razor device of claim 1, wherein the cutting component can retain a full-size blade within the blade retainer.

7. The razor device of claim 1, wherein the blade retainer is designed to accommodate razor blades of sizes 2.5 cm, 5 cm, and 7.5 cm.

8. The razor device of claim 1, wherein the slide mechanism is configured to move from a first position, which is a locking position, to a second position, which is a release position, to secure or release the razor blade from the blade retainer.

9. The razor device of claim 1, wherein the blade adaptor is configured to receive a smaller blade within a hollow retention area, securing the razor blade at multiple points along its length for stability during intricate grooming tasks.

10. The razor device of claim 1, wherein the slide mechanism comprises a locking device configured to attach to a portion of a base of the razor blade when in a locked position, thereby securing the razor blade firmly within the blade retainer.

11. The razor device of claim 1, further comprising a removable grip insert attachable to the hollow portion of the handle, the removable grip insert being configured to provide a customizable texture or size to accommodate different user preferences.

12. The razor device of claim 1, wherein the swivel pivot point includes a multi-stage detent mechanism configured to lock the cutting component at one or more predetermined angles relative to the handle, enhancing stability during extended or detailed shaving tasks.

13. The razor device of claim 1, further comprising an adjustable tension system coupled to the slide mechanism within the blade retainer, the adjustable tension system being configured to fine-tune frictional engagement between the blade retainer and the blade adaptor for consistent blade insertion and removal.

14. The razor device of claim 1, further comprising a secondary latch integrated into the handle and configured to engage the cutting component when the razor device is in a closed position, preventing unintentional opening or blade exposure during storage or transport.

15. The razor device of claim 1, wherein the hollow portion of the handle includes a protective lining formed of a resilient material, the protective lining reducing friction between the cutting component and the handle when the razor device is in the closed position.

16. The razor device of claim 1, further comprising an alignment guide disposed along an interior surface of the blade retainer, the alignment guide being configured to ensure precise positioning of the blade adaptor or razor blade during insertion.

17. The razor device of claim 1, wherein the swivel pivot point includes an adjustable tension dial that allows a user to vary a resistance to pivoting of the cutting component relative to the handle, providing customizable control during shaving.

18. The razor device of claim 1, wherein the distal end of the blade retainer includes a visual alignment window allowing a user to confirm correct seating of the blade adaptor or razor blade within the blade retainer prior to use.

19. The razor device of claim 1, further comprising a safety guard pivotally mounted near the distal end of the cutting component, the safety guard being moveable between a retracted position for shaving and an extended position for protecting the blade when the razor device is stored.

20. The razor device of claim 1, wherein the blade retainer includes a magnetic element configured to interface with a corresponding magnetic element on the blade adaptor or razor blade, thereby assisting in stabilizing and retaining the blade until the slide mechanism is activated for release.
